(19) United States
(12) Patent Application Publication
(10) Pub. No.: US 2006/0226700 A1
(43) Pub. Date: Oct. 12, 2006

(54) Electromagnetic retarder for a vehicle provided with a speed increasing unit

(75) Inventor: Zeng Gang Liu, Maurecourt (FR)

Correspondence Address: OSHA LIANG L.L.P., 1221 MCKINNEY STREET, SUITE 2800, HOUSTON, TX, 77010, US

(73) Assignee: TELMA, Saint-Ouen-Laumone (FR)

(21) Appl. No.: 10/523,439

(22) PCT Filed: Jul. 9, 2003
(86) PCT No.: PCT/FR03/02133

§ 371 Date: Sep. 6, 2005

(30) Foreign Application Priority Data
Jul. 29, 2002 (FR) 02/09601

(51) Int. Cl. B60T 8/64

(52) U.S. Cl. 303/152

(57) ABSTRACT

The aim of the invention is to reduce the weight and sizes of an electromagnetic retarder (1) for a vehicle by coaxially offsetting said electromagnetic retarder with respect to the transmission (4) of the vehicle, the retarder being provided with a cooling cavity. In order to coaxially offset the retarder, a speed increasing gear (16) is incorporated between said electromagnetic retarder and transmission.

### DOMAIN

The invention concerns an electromagnetic retarder for a vehicle equipped with a speed increasing gear. The purpose of the invention is to increase the performance of such a retarder, reduce the weight and size of this retarder. The invention is more specifically intended for trucks, coaches and buses, i.e. vehicles of the “heavy weight” class, but may also be applied in other domains.

### STATE OF THE TECHNOLOGY

An electromagnetic retarder assists a vehicle braking device, particularly for “heavy weight” vehicles. A braking device may contain brake pads intended move toward at least one disk of a wheel hub of a vehicle to brake the vehicle. There are several types of electromagnetic retarders. In particular, there are electromagnetic retarders of the axial type, electromagnetic retarders of the “Focal” type (registered trademark), and electromagnetic retarders of the “Hydral” type (registered trademark). An axial electromagnetic retarder is intended to be placed on the movement transmission line between an axle and a transmission on the vehicle; the drive shaft is in two parts for mounting the retarder between them. A “Focal” type electromagnetic retarder is intended to be placed directly on a drive shaft at the outlet to the transmission or directly on the axle of the vehicle. The axle of a vehicle drives at least one wheel axle, which wheel axle drives at least one wheel of this same vehicle. A “Hydral” type electromagnetic retarder is also designed to be placed directly on a drive shaft at the outlet of the transmission. This “Hydral” type electromagnetic retarder is particularly adapted to vehicles with a short shaft line.

Such a “Hydral” type electromagnetic retarder, described for example in document FR A 2 627 913 and its corresponding documents EP-A-331 559 and U.S. Pat. No. 4,864,173, contains at least one armature stator and at least one winding rotor. The armature stator can include a hollow, circular cylindrical shape that allows the winding rotor, which also has a smaller, hollow, circular, cylindrical shape, to be inserted inside the stator with the presence of an air gap. The rotor is intended to turn around an axis of the stator because of the transmission of a rotating movement to the rotor through the vehicle's drive shaft. The rotor, in one form of fabrication, has at least one magnetic coil. Thus, the armature stator is provided to ensure the passage of a magnetic field produced by the coils. In the axial or “Focal” type retarders, it is the opposite; in this case, the stator is a winding stator that contains the coils, while the rotor is an armature rotor.

Generally, electromagnetic retarders contain an even number of coils with alternate polarity. A coil has a hollow circular, cylindrical shape. Of course, the shape can be different from circular and can, for example, be elliptical or another shape. A coil is formed by winding an electrical wire in a circular, cylindrical shape. The coil is supported by a core, and the core is attached to the stator along an axis of the core perpendicular to the plane of the stator and coaxial to an axis of the retarder. In one example, the coils are formed by a copper wire. The winding of the copper wire defines an axis of the coil perpendicular to the direction of the winding of the electrical wire, and this axis of the coil is merged with the axis of the core. In the case of the “Hydral” type electromagnetic retarder, the coils, which are each supported by a core in the shape of a protuberance, may be distributed uniformly and radially in relation to an axis of the rotor, with their coil axis perpendicular to the plane of the winding rotor and the plane of the armature stator.

Preferably, the coils operate in pairs. Each of the coil pairs is intended to form a magnetic field that closes from one to the other, passing into the rotor and the stator. This magnetic field is created when one wants to slow the rotor that turns around an axis of the stator.

In the case of the aforementioned “Hydral” retarder, this magnetic field is formed by crossing the core [of] the first coil supported by the armature rotor along an axis of this first coil, then it enters the stator perpendicular to the plane of the stator.

The plane of the stator can be formed by the wall of the stator, for example, made of ferromagnetic material. Then the magnetic field continues into the stator parallel to the plane of the stator and parallel to one rotating direction of the rotor. Then the magnetic field joins the core of the second coil by leaving perpendicular to the plane of the stator along an axis of this second coil. Finally, the magnetic field forms a loop by again rejoining the first coil, passing from the second coil through the rotor. When the electromagnetic field crosses the plane of the stator perpendicularly, an electric current or Foucault current is created in the stator because of the displacement of the rotor.

In effect, in accordance with Faraday's law, an electrical conductor that moves in a field produces voltage at its terminals, which is the vector product of this field by the displacement speed. This vector product is at its maximum when the field is perpendicular to the speed. Everything happens as if an electric voltage was produced in spaces in the rotor where each of the coil axes cuts the plane of the stator, while no voltage is produced between these two locations. Between these spaces, the magnetic field, which is tangential to the plane of the rotor, is parallel to the direction of displacement of the rotor. The Foucault currents generated are located in spaces in the stator where the magnetic field crosses the rotor.

More specifically, the Foucault currents are generated in the stator only at the place where there is a component of the magnetic field that is perpendicular to the rotating direction of the rotor. Such an electric current, or Foucault current, is intended to work against the rotation speed of the rotor. It is this Foucault current that is used to slow the rotation speed of the vehicle shaft; the rotor is linked to the drive shaft and the drive shaft is itself linked to at least one wheel of the vehicle. Thus, it appears in the current system that the electromagnetic retarders drive the braking of the vehicle following opposition to the rotation movement of the rotor through the cross member perpendicular to the plane of the stator of at least one magnetic field between two coils.

To cool the electromagnetic retarder after heating of the stator wall by the Foucault currents, the wall of the stator has a cavity or cooling surface within which a fluid is intended to enter and circulate to cool the stator.

To increase the performance of such electromagnetic retarders, it is possible to increase the number of coils. By increasing the number of coils, the power of such an electromagnetic retarder can increase because of the increase in the places in the stator where the power of the Foucault current is maximum as the result of the increase in the number of corresponding pairs of coils.

It is also possible to increase the number of coils by reducing the size of the coils to make larger and larger retarders more powerful. In addition, the fabrication of such an electromagnetic retarder with a large number of coils can increase the fabrication cost of such a retarder.

However, it has been realized that, by increasing the number of coils, the weight and size of such a retarder was increased. In addition, this would increase the cost of such a retarder.

### PURPOSE OF THE INVENTION

To reduce the weight and size of these electromagnetic retarders, the invention provides for offsetting the electromagnetic retarder in relation to the transmission.

To offset the electromagnetic retarder in relation to the transmission, a speed increasing gear can be inserted between the transmission and the electromagnetic retarder. This speed increasing gear integrated in the electromagnetic retarder will increase the performance of the electromagnetic retarder. This speed increasing device can be a speed increasing device with gear, possibly a bevel gear. This speed increasing gear is fabricated so that the transmission works with the retarder through a first disk and a second disk respectively. The first disk and the second disk each have, on the outside, teeth made so that the teeth of the first disk are inserted between the teeth of the second disk because they are complementary and the action is reciprocal. For the rotation speed of the rotor to increase, the first disk is larger than the second disk.

By offsetting the electromagnetic retarder to the transmission, it is possible to reduce the space used by this retarder by reducing its size. The reduction in the size of the electromagnetic retarder is possible because it is no longer necessary to have the transmission pass directly into the electromagnetic retarder.

As a reduction in the size of the electromagnetic retarder can result in a reduction in the thermal capacity of the electromagnetic retarder, the invention also provides for extending the cooling surface of the stator. The cooling cavity or cooling surface is then extended by extending the wall of the stator to one end of the stator that is generally perpendicular and in the direction of one axis of the stator. The portion of the wall extended is then, for example, hollow and continuous with the cooling surface to form a frontal cooling surface.

Generally, the extended portion of the wall carries an extension of the cooling surface or cavity.

As a result of the increase in the rotation speed of such an electromagnetic retarder equipped with this speed increasing device, the wall of the stator tends to heat up significantly. The invention also provides for cooling of the wall of the stator by a fluid, primarily by water. Water is a fluid particularly well suited to cool such a stator wall in the case of such an increase in the heat. But another fluid could be used as well.

Thus, the purpose of the invention is an electromagnetic retarder, primarily for a vehicle, arranged between a brake pedal and between at least one wheel of the vehicle, intended to assist the braking of the vehicle through a transmission, and which includes a stator cooled by the circulation of a cooling fluid circulating in at least one cavity in said stator, characterized in that it is offset in relation to the transmission.

### BRIEF DESCRIPTION OF DIAGRAMS

The invention will be better understood by reading the description that follows and reviewing the accompanying diagrams. These diagrams are presented only as an indication and do not in any manner limit the invention. The figures show:

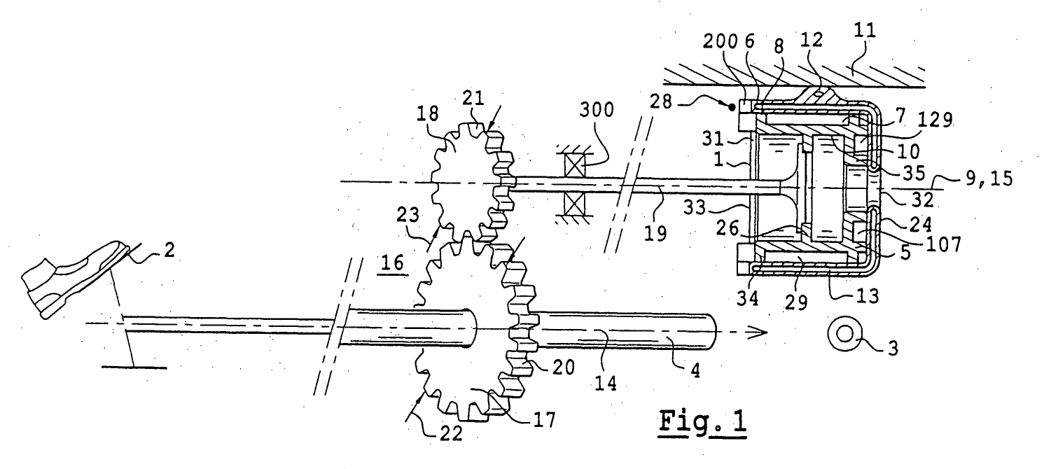

FIG. 1: a schematic representation of an electromagnetic retarder of a vehicle according to the invention;

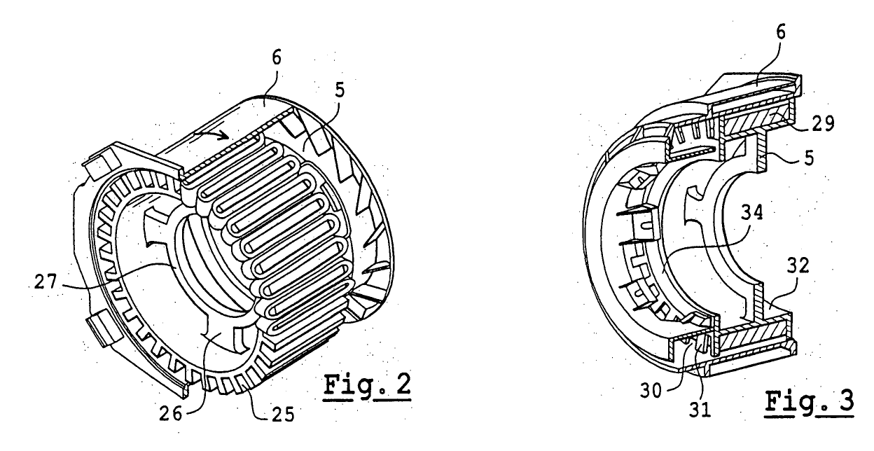

FIG. 2: a drawing in perspective of an electromagnetic retarder of a vehicle according to the invention;

FIG. 3: a drawing in perspective of an electromagnetic retarder of a vehicle according to a variant of the invention.

### DESCRIPTION OF PREFERRED EXAMPLES OF FABRICATION OF THE INVENTION

FIG. 1 shows an electromagnetic retarder 1, particularly for a vehicle, arranged between a brake pedal 2 and between at least one wheel of the vehicle 3, intended to assist in braking the vehicle through a transmission 4 according to the invention.

The electromagnetic retarder contains at least one winding rotor 5, at least one armature stator 6 and at least one coil 7. In the example in FIG. 1, this electromagnetic retarder is a “Hydral” type electromagnetic retarder described, for example in document FR A 2 627 913 cited above, to which the reader may refer for more details, but could be an axial type or a Focal type electromagnetic retarder, as previously mentioned. A Focal type retarder is described, for example, in document FR A 2 577 357 to which the reader may refer for more information. In this same example of FIG. 1, the rotor 5 is inserted inside the stator 6, which is to be mounted on a fixed part of the vehicle, here the chassis 11. A small gap, called the air gap, is present between the rotor 5 and the stator 6 to create an electromagnetic link that is described below.

Thus, the stator surrounds the rotor, which are both annular in shape and are coaxial. The axial axes of symmetry 9, 15, of the rotor and stator respectively, which are of ferromagnetic material here, are combined.

The rotor has a wall with a hollow circular, cylindrical shape that is inserted into a wall of the stator, which is also in a complementary hollow cylindrical, circular shape.

Said walls are, therefore, axial in orientation by considering axes 9, 15.

The wall of the rotor delimits an exterior surface 8 at a distance from axis 9 of the rotor, and an internal surface 10 close to the axis of the rotor. Coil 7 is carried by the external surface 8 of the rotor wall and is designed to form a magnetic field between the rotor 5 and the stator 6. The rotor may have at least one coil 7 and this is why the external surface 8 is, in FIG. 1, hollow at 29 in one U-shaped section to receive the coil 7 as described below. In the example in FIG. 2, the rotor may have several coils and contain mounting grooves 25 for this purpose. Preferably, the rotor may have an even number of coils.

The wall of the stator has at least one cooling cavity or surface 13 inside of which a cooling fluid is to circulate. This fluid, such as water, is intended to cool the wall of the stator.

Here, the wall of the stator is hollowed out on the inside to form the cooling cavity. As a variant, as described in document EP-A-331 559, the cavity is formed as a conduit that extends in a helix around the wall of the stator and is supported by this wall.

This conduit ends with two input and output connectors. As a variant, the cavity is delimited by the wall and by a cover attached to the wall.

One of the wall cover elements is hollow to create the cavity.

In a variant, the wall and the cover are hollow. Generally, all fabrication forms described in document EP-A-331 559 (U.S. Pat. No. 4,864,173) can be envisioned, and the cooling liquid is advantageously water with antifreeze. This cooling liquid is advantageously the cooling liquid of the thermal engine; the pump and the heat exchanger of the cooling circuit is advantageously the water pump and the cooling radiator of the automobile.

The electromagnetic retarder is connected, first, to a chassis 11 and, second, to the transmission 4 that contains a drive shaft, the axis of which is shown at 14. The link of the electromagnetic retarder to the chassis is achieved through at least one linking device 12. This linking device 12 is here arranged on the stator to connect the stator to the chassis 11. The link of the electromagnetic retarder to the transmission is achieved through the rotor 5.

According to one characteristic of the invention, the electromagnetic retarder is offset in relation to the transmission 4. The offset position of the electromagnetic retarder in relation to the transmission can be achieved coaxially so that one axis of the electromagnetic retarder is offset parallel to an axis 14 of the transmission 4. One axis of the electromagnetic retarder corresponds to axis 9 of the rotor, which itself corresponds to one axis 15 of the stator.

The size and, therefore, the space and weight of the retarder can be reduced.

The offset position of the electromagnetic retarder in relation to the transmission can be achieved through a speed increasing device 16. This speed increasing device can be a gear device that contains, for example, two toothed wheels described below. However, this speed increasing device could be a speed increasing device with belts or a speed increasing device with chains. With these arrangements, the weight and space of the retarder are reduced; the heat is released by circulation of the cooling fluid inside the cavity of the armature stator 6

This speed increasing gear contains a first disk 17 and a second disk 18, which each belong to a toothed wheel. The first disk 17 is inserted in the transmission 4, and is integrated with the drive shaft so that one plane of this first disk is perpendicular to axis 14 of the transmission. The second disk 18 is carried by the rotor 5 through an arm 19; this arm is attached to the rotor of the electromagnetic retarder. More specifically, the arm 19 contains a shaft at one end of which is attached the disk 18. The shaft has the same axis as the axes 9, 15 and enters the rotor. At the other end, the shaft has a plate with a transversal orientation in relation to axes 9, 15 for mounting on at least one transversal protuberance 26, described below, contained inside the rotor. The arm 19 has the general shape of a valve on the free end of which disk 18 is mounted.

This second disk 18 is placed in such a way that one plane of this second disk is perpendicular to axis 9 of the rotor. Thus, the first disk and the second disk both have one parallel plane between them. The first disk and the second disk are arranged so that they are placed one under the other according to a plane that is perpendicular to axis 14 of the transmission 4 and axis 9, 15 of the electromagnetic retarder.

The first disk and the second disk contain on the periphery 20 and 21 respectively a series of teeth so that two toothed wheels are formed. The transmission 4 and the electromagnetic retarder 1 cooperate through the insertion of each of the teeth of the first disk 17 between each of the teeth of the second disk 18 because they are complementary and reciprocal, FIG. 1. The shape of the teeth is such that the teeth can be inserted into each other because they are complementary. Thus, the teeth can be triangular so that the points extend radially in relation to a center of the first disk and to a center of the second disk. The center of the first disk may correspond to a space on the first disk where the axis of the transmission is likely to cross the first disk. The center of the second disk may correspond to a place on the second disk where the axis of the retarder is likely to cross the second disk. Or the teeth can be rectangular or trapezoidal in shape, or may advantageously have a circle arc shape like conventional gears.

Thus, the transmission transmits a rotation movement to the first disk, and the first disk also transmits a rotation movement to the second disk through the teeth. The second rotating disk thus drives the rotation of the winding rotor through arm 19.

To increase the rotation speed of the rotor, the first disk 17 has an outside diameter 22 that is larger than the outside diameter 23 of the second disk 18. The increase in the rotation speed of the rotor is achieved so that the second disk can turn on itself several times to travel the full length of the periphery 20 of the first disk 17. The increase in the rotor rotation speed is, therefore, proportional to the decrease in the diameter 23 of the second disk in relation to the diameter 22 of the first disk. The second disk that is smaller than the first disk is, therefore, a pinion.

In a variant, the disks are perpendicular and the teeth are in sections so that the axis of the retarder is perpendicular to the axis of the transmission. The increasing device 16 then has a cone-shaped coupling.

An electromagnetic retarder works in the following manner. When a vehicle is braked, a magnetic field is created that is formed by at least one coil that, in this case, is in the winding rotor. This magnetic field crossing the stator is the origin of the formation of the Foucault currents in the armature stator made of a magnetic material, advantageously a ferromagnetic material. By passing through the stator, the magnetic field creates a zone of Foucault currents at a place in the stator where the magnetic field crosses the plane of the stator perpendicularly. As previously mentioned, the plane of the stator is formed by the wall of the stator. The Foucault currents are electric currents that increase in power as the magnetic field forming between the coils tends to be perpendicular in relation to the direction of rotation of the rotor. The direction of rotation of the rotor is a direction perpendicular to the plane of the sheet of the drawing in FIG. 1 and is represented by point 28 on FIG. 1. By being perpendicular to the direction of rotation of the rotor, the magnetic field forms Foucault currents that tend to oppose the rotation movement of the rotor. By opposing the direction of rotation of the rotor, the Foucault current generates braking or a slowing of the rotation of the rotor transmitted indirectly by the transmission according to the invention. Braking controlled by pressing a conductor on the brake pedal is then assisted by such an electromagnetic retarder following the slowdown or at the shutdown of the movement of rotation of the transmission in the direction of at least one vehicle wheel.

Such an offset positioning of the electromagnetic retarder (here transversal to the transmission) reduces, as described above, the size of the electromagnetic retarder because it is no longer necessary to have the transmission cross directly through the interior of the rotor. The link from the transmission to the retarder is achieved indirectly through the arm 19, which can have a diameter smaller than the diameter of the transmission. However, a reduction in the size of the electromagnetic retarder can result in a reduction in the thermal capacity of the electromagnetic retarder. Thermal capacity means the quantity of matter of the stator that can be heated, particularly by the Foucault currents. During the operation of the electromagnetic retarder, the stator as reduced is rapidly heated as a result of the circulation of the Foucault currents in the wall of the stator. The heating of the stator can be the origin of a decline in the performance of the retarder, because the heat tends to prevent the formation of Foucault currents in the stator.

This is because, according to the invention, the transmission is offset in relation to the retarder, the wall of the stator is extended, here generally transversal in relation to axis 9, 15, in order to increase the cooling surface. The stator has one end 32 at a distance from the second disk 18 and one end 33 close to the second disk 18. The wall of the stator is thus extended perpendicularly in the direction of axis 9 of the rotor at the end 32 of the stator separated from the second disk 18. Thus, it is possible to increase the cooling surface of the stator by also extending the cavity 13 of the stator. To extend the cavity of the stator, a portion of the wall corresponding to the wall extended perpendicularly to axis 9 of the stator can be hollowed out to form a frontal surface 24 that generally has a transversal orientation.

As a variant, the wall is extended transversally to carry a generally transversal extension of the aforementioned conduit that forms the cavity

As a variant, the aforementioned cover is extended transversally to be carried by the generally transversal extension of the wall and delimit, with this extension, the extension of cavity 13

In effect, as described above, the wall has a cavity that has been hollowed out, for example. The wall could also have several cavities. Preferably, the wall is hollowed out with a single cavity. This cavity is intended to be filled with a fluid that cools the wall of the stator during the increase in the rotation speed of the rotor. This fluid circulates in the cavity. The fluid is intended to fill the cavity and cool the wall of the stator and can be water. Water is a fluid particularly well adapted to a very strong increase in the heat of the stator wall following an acceleration of the rotor rotation speed. But the fluid could also be another liquid. The fluid could also be air. The cavity of the stator could be in communication with another device (not shown) outside or part of the electromagnetic retarder intended to cool the fluid circulating in cavity 13 of the stator. This device would allow the fluid to circulate inside the stator and leave the stator to be cooled by this same device.

For Foucault currents to form in the stator, prior excitation of at least one coil is necessary for the formation of a magnetic field. Prior excitation can be obtained through an excitation alternator such as the one shown in document FR A 2 627 913 cited above. The alternator, shown at 200 on FIG. 1, has a winding stator with multiple poles that surrounds, with a small gap, i.e. an air gap, a polyphased armature rotor, for example a triphased rotor. The poles are created by a ring of alternating electromagnets connected to a direct current source like the battery of a vehicle. The electromagnetic link between the rotor and the stator is achieved through the air gap between the rotor and the stator of the alternator without mechanical contact. A regulating circuit is provided to regulate, as desired, the amperages of the winding stator. The regulating circuit has a manual regulating element, such as a lever. The regulating element is, in a variant, associated with the brake pedal. This alternator starts when a foot presses a conductor on the brake pedal and/or on the aforementioned lever provided for this purpose. The alternating current collected in the phases of the armature rotor is rectified by a bridge rectifier, of the diode type for example, before being applied to the coil or coils 7 to supply electricity to the coils. For more details, refer to FIGS. 1 and 2 of document FR A 2 627 913. Rotor 5 and stator 6 are, therefore, extended axially at the level of the end 33 to carry the rotor and stator respectively of the alternator.

According to the invention, this excitation alternator is placed in the electromagnetic retarder. In particular, this alternator is positioned partially in the winding rotor and partially in the armature stator.

In a variant, the excitation alternator is a production automobile alternator, such as the one with internal ventilation described in document FR A 2 676 873 (U.S. Pat. No. 5,270,605) to which the reader should refer for more information. More specifically, it is enough to reverse the structures. In other words, the rotor with clamps and the excitation coil in document FR A 2 676 873 becomes, through its shaft, integrated with the chassis and, therefore, with stator 6 of the retarder of the invention, while the two hollow flanges in this document FR A 2 676 873, mounted together using screws or any other method to form a case carrying the polyphased stator and the bridge rectifier, become integrated with the rotor 5 of the retarder and arm 19. This is made possible because each of the flanges carries in the center a ball bearing that intervenes between this flange and the relevant axial end of the rotor shaft. The rotor of this document FR A 2 676 873 becomes an excitation stator with clamps, while the polyphased stator of document FR A 2 676 873 becomes an armature rotor surrounding the excitation stator or winding stator. This rotor has a body in the form of a pack of grooved sheets for mounting a winding that has several windings connected to the electric power bridge rectifier of the coils 7. The stator has two polar wheels with clamps, with a core between them that has a winding coil. In this case, we eliminate the regulator mounted inside this production alternator, and the winding coil is powered from the outside.

Of course, it is necessary to modify the mounting tabs on these flanges so that they are distributed uniformly to avoid any problem; these tabs are mounted on the internal protuberances 26 of rotor 5, while the pulley of document FR A 2 676 273 is replaced by a mounting element, such as a disk, intended to be mounted at the edge of the central opening of the perpendicular extension of the end 32 of the armature stator 6.

It is also necessary to modify the flange carrying the bridge rectifier with diodes so that this flange carries spacers, for example molded with this flange, used to mount the arm 19. As a variant, this flange forms a cap, as seen for example in FIG. 9 of application PCT/FR 02/01631; arm 19 is mounted on the stacks presented by this flange.

The bridge rectifier is then connected electrically to the coils 7 to supply electricity to them. In this case, the alternator is located, at least mostly, inside the hollow winding rotor 5. This is made possible because of the invention.

To carry the coils 7, the winding rotor 5 has on its external surface at least one core in the form of a protuberance 25 extending radially and perpendicularly in relation to the axis 9 of the rotor and in the opposite direction to the axis of the rotor, FIG. 2. Protuberance 25 forms a projecting pole and is made of a magnetic material, advantageously ferromagnetic. These protuberances, with an oblong shape axially, form a support around which a coil 7 is formed. The rotor can have an even number of protuberances so that the coils can form a magnetic field per pair of coils. On the internal surface 10 of the rotor, at least one projection 26 is arranged, which extends radially in the direction of the axis 9 of the rotor. In one example, the rotor can have four protuberances and these protuberances can be connected to each other by a ring 27. These protuberances allow the insertion and mounting of arm 19 which carries the second disk 18 of the speed increasing device 16. The arm 19 can be inserted in the rotor by mounting on ring 27.

A magnetic field can be formed from one coil to another coil by passing through the protuberance of each of these coils. The magnetic field is intended to cross the plane of the stator and the plane of the rotor. By crossing the plane of the stator, the magnetic field crosses the plane of the stator perpendicularly first, then parallel to the plane of the stator, and finally a second time perpendicularly to the plane of the stator to reach the rotor. Between the two locations where the magnetic field crosses the stator perpendicularly to the plane of the stator, the magnetic field is parallel to the direction or rotation of the rotor. The direction of rotation of the rotor is shown by an arrow on FIG. 2. According to the example in FIG. 2, the Foucault current zones are formed only in the places where the magnetic field crosses the plane of the stator perpendicularly.

To improve the power of such an electromagnetic retarder which can be provided by the Foucault currents crossing the stator, it is possible to arrange the coils on the rotor according to another variant of the invention in FIG. 3. FIG. 3 is a perspective of the position of the coils according to this other variant of the invention. According to this other variant, the coils are arranged on the rotor so that the magnetic field formed by these coils presents a radial configuration in relation to the rotor axis. According to this radial configuration in FIG. 3, the coils can be arranged so that they form a magnetic field that crosses the stator and is still perpendicular to the direction of rotation of the rotor. According to this variant, there is more than one coil wound around the rotor. The electromagnetic retarder of FIG. 1 is also shown in this variant. According to this radial configuration, the magnetic field formed by this single coil in the stator still crosses perpendicularly, then parallel to the plane of the stator, but circulates inside the stator perpendicular to the direction of rotation of the rotor. According to this example in FIG. 3, the Foucault currents are at the maximum power during their entire travel in the stator.

To do this, the rotor is hollowed out, on its wall on the side of the outside surface 8 perpendicular to and in the direction of axis 9 of the rotor or axis 15 of the stator, with a cavity 29 the length of the rotor. This cavity is intended to accept a magnetic coil. This cavity is delimited by one end 34 of the rotor that is closed to the end of the rotor and close to the second disk 18 and by another end 35 closed to end 32 of the stator and at a distance from the second disk, and located opposite the frontal surface 24 of the stator. According to this radial configuration, these two ends 34 and 35 of the rotor are hollowed out with at least one window each. At least one window 30 is shown in FIG. 3 on the end 34 of the rotor. These windows are formed radially in relation to axis 9 of the rotor and are hollowed out in the direction of this axis. Between these windows are tongues 31 corresponding to a section of the rotor wall. A magnetic field can be formed from a tongue of one end with another tongue from the other end of the rotor. The magnetic field formed between two tongues is created so that it still crosses the stator perpendicularly to the direction of rotation of the stator. Because of its position perpendicular to the direction of rotation of the stator, the magnetic field can create a zone of Foucault currents with a power as high as in the two locations where the magnetic field perpendicularly crosses the plane of the stator. This variant according to the invention FIG. 3 increases even more the performance of such an electromagnetic retarder without requiring an increase in the weight or the size of the retarder or the coils.

In FIG. 1, the rotor is also extended perpendicularly in the direction of axis 9.

This extension with a transversal orientation extends opposite surface 24 of the stator 6 to the area near the end 32 of the stator. This extension is hollowed out to form an annular mounting cavity 129 intended to accept a magnetic coil 107 perpendicular to the coil housed in the annular cavity 29.

Of course, it is advantageous to provide at least one bearing 300 between the shaft of arm 19 and the chassis to support the shaft 19 and guarantee the air gap between the stator 6 and the rotor 5.

As a variant, the disks 17 and 18 are replaced by pulleys that accept a belt operating between the two pulleys.

As a variant, the two disks are separated from each other and connected by a chain.

All these variants represent various forms of a speed increasing device operating between the transmission 4 and the arm 19 integrated with the rotor 5.

Thus, as described above, disks 17 and 18 can be perpendicular and form an angle transmission.

The retarder can be located perpendicular to the transmission 4.

As a variant, the frontal wall 24 could be slightly inclined so that it is generally transversal in orientation.

As a variant, the wall of the stator is not constant in thickness.

As a variant, the retarder is the axial or Focal type so that the arm 19 is mounted on the armature rotor.

1-8. (canceled)

9. An electromagnetic retarder adapted to be arranged between a brake pedal and at least one wheel of a vehicle for assisting braking thereof through a transmission, the electromagnetic retarder comprising:
a rotor; and
a stator, wherein the stator has at least one cavity formed therein and arranged to allow circulation of fluid therethrough for cooling the stator;
wherein the electromagnetic retarder configured to be offset in relation to the transmission.

10. The electromagnetic retarder of claim 9, wherein the rotor and the stator are coaxial and define an axis of the electromagnetic retarder, and wherein the axis of the electromagnetic retarder is offset from and parallel to an axis of the transmission.

11. The electromagnetic retarder of claim 9, further comprising a speed increasing device for connection to the transmission.

12. The electromagnetic retarder of claim 11, wherein the speed increasing device comprises a gear device.

13. The apparatus of claim 12, wherein the electromagnetic retarder comprises an arm integrated with the rotor, and wherein the speed increasing device is disposed between the arm and a shaft of the transmission.

14. The electromagnetic retarder of claim 9, wherein:
the rotor is disposed within the stator and configured to rotate about an axis of the stator; and
the at least one cavity is formed within a wall of the stator and is extended by an extension supported by the wall that extends to an end of the stator generally perpendicular to a central axis of the electromagnetic retarder.

15. The electromagnetic retarder of claim 14, further comprising:
at least one coil; and
an excitation alternator configured to provide electric power to the coil.

16. The electromagnetic retarder of claim 15, wherein:
the rotor is hollow; and
the excitation alternator is disposed at least partially inside the rotor.
